(19) United States
(12) Patent Application Publication
(10) Pub. No.: US 2026/0325397 A1
(43) Pub. Date: Oct. 22, 2026

(54) Manual Telescoping Massage Device

(71) Applicant: YOULI WANG, Guang'an City (CN)

(72) Inventor: YOULI WANG, Guang'an City (CN)

(21) Appl. No.: 19/183,935

(22) Filed: Apr. 21, 2025

(51) Int. Cl. A61H 19/00; A61H 7/00; A61H 23/02

(52) U.S. Cl. CPC A61H 19/30; A61H 7/003; A61H 23/0263; A61H 2201/1669; A61H 2201/1671; A61H 2201/5025

(57) ABSTRACT

A manual telescoping massage device is disclosed, comprising: a first massage module having a first massage member that defines a first massage channel; a second massage module having a second massage member that defines a second massage channel; and an unpowered telescoping structure interconnecting the first massage module and the second massage module so that the second massage module is mounted on an upper end of the first massage module for relative telescoping movement, with the second massage channel aligned with and spaced above the first massage channel. During massage of an object by the first massage member, manual actuation of the telescoping structure causes the second massage module to slide relative to the first massage module, thereby bringing the second massage member into engagement with the object for a secondary massage and achieving segmented massage. The device features a simple, power-free structure and reduced manufacturing cost.

### TECHNICAL FIELD:

The present invention relates to the technical field of telescoping massage, and in particular to a manual telescoping massage device.

### BACKGROUND ART

Chinese Patent Publication No. CN 111467208 B discloses a telescoping and rotating massage device, comprising a housing and, inside the housing, a telescoping mechanism, a rotary mechanism, an auxiliary connector, and a massage member. The telescoping mechanism includes a telescoping driver and a guide-rod assembly. The telescoping driver is fixed inside the housing; one end of the guide-rod assembly connects to the telescoping driver, and the other end connects to the auxiliary connector. The rotary mechanism includes a rotary driver, a driven member, and a driven telescoping member. The rotary driver is fixed inside the housing and connects to the driven member. The driven telescoping member is sleeved on the driven member; one end of the driven telescoping member passes through the auxiliary connector and fixedly connects to the massage member. The auxiliary connector is arranged between the massage member and the driven telescoping member.

First, the massage member in the prior art is a one-piece structure that cannot perform segmented massage and thus fails to meet certain users'needs. Furthermore, the telescoping mechanism in the prior art requires a powered driver (i.e., a motor assembly), resulting in a complex structure and high cost that undermines market competitiveness.

In view of the above, the present inventor has proposed the following technical solution.

### SUMMARY OF THE INVENTION

An object of the present invention is to overcome the deficiencies of the prior art and to provide a manual telescoping massage device.

To solve the above technical problem, the present invention adopts the following technical solution:

A manual telescoping massage device comprising: a first massage module, which has a first massage member defining a first massage channel; a second massage module, which has a second massage member defining a second massage channel; and an unpowered telescoping structure connecting the first massage module and the second massage module so that the second massage module is mounted to the upper end of the first massage module in a manner permitting relative telescoping movement, and the second massage channel aligns with and is spaced above the first massage channel.

Further, in the above technical solution, the telescoping structure comprises a plurality of guide rods fixed to the first massage module and a plurality of telescoping slide-slots formed in the second massage module; each guide rod extends through a corresponding slide-slot and can slide telescopically within that slide-slot.

Further, in the above technical solution, an anti-disengagement structure is provided between each guide rod and its slide-slot. The anti-disengagement structure either comprises: a constricted mouth of reduced size at the lower end of the slide-slot and an anti-disengagement block of enlarged size mounted on the upper end of the guide rod, the anti-disengagement block sliding in the slide-slot but being too large to pass through the constricted mouth; or comprises: a travel-limit block on the inner wall of the slide-slot and a travel-limit groove on the outer side of the guide rod, the travel-limit block engaging the travel-limit groove.

Further, in the above technical solution, the first massage member carries a mid-peripheral annular groove in which a first outer housing is seated flush with the periphery of the first massage member; each guide rod is fixed to the first outer housing. The second massage member carries a mid-peripheral annular groove in which a second outer housing is seated flush with the periphery of the second massage member; the lower end of the second outer housing defines the telescoping slide-slots. A first relief groove is formed around the upper end of the first massage member to accommodate the guide rods; similarly, a second relief groove is formed around the lower end of the second massage member.

Further, in the above technical solution, a vibration device is mounted on the outer side of either the first massage member or the second massage member; the combination of the first massage module, the telescoping structure, and the second massage module forms a dumbbell shape.

Further, in the above technical solution, the first massage member is enclosed by a first outer housing that extends upward beyond the upper end of the first massage member to form an extension tube having an internal slide-slot; the second massage member is enclosed by a second outer housing that extends downward beyond the lower end of the second massage member to form a sliding tube which is slidably received in the extension tube's slide-slot to form the telescoping structure. The upper end of the extension tube is turned inward to form an anti-disengagement flange, and the lower end of the sliding tube bears an outward-projecting sliding flange that contacts the slide-slot's inner wall.

Further, in the above technical solution, the telescoping structure comprises a plurality of springs whose upper ends are fixed to the lower end of the first massage module and whose lower ends are fixed to the upper end of the second massage module.

Further, in the above technical solution, the telescoping structure comprises a corrugated elastomeric bellows integrally joined at its upper end to the lower end of the second massage member and at its lower end to the upper end of the first massage member, the bellows'internal cavity being larger than the cross-sections of both massage channels.

Further, in the above technical solution, two first massage modules are provided along with one second massage module; the telescoping structure comprises guide rods fixed between the two first massage modules and guide-slots in the second massage module, the second massage module being sleeved on the guide rods via the guide-slots for telescoping movement, and the second massage channel being coaxial with the first massage channels of both first massage modules.

Further, in the above technical solution, the second massage module includes a rigid outer housing, a rotatable inner housing mounted within the rigid outer housing, an external gear ring fixed to the lower end of the rotatable inner housing, a motor mounted inside the rigid outer housing, and a driving gear on the motor shaft meshing with the external gear ring; the second massage member is installed within the rotatable inner housing. The rigid outer housing also houses the guide-slots and a control circuit board electrically connected to the motor, and bears an external control switch electrically connected to the control circuit board.

Compared with the prior art, the present invention uses an unpowered telescoping structure to interconnect the first massage module and the second massage module, forming a manual telescoping massage device. The first and second massage modules cooperate to massage an object (e.g., a male penis) first through the first massage channel and then, by manual telescoping, through the second massage channel for a secondary segmented massage, meeting diverse user requirements. Moreover, the manual telescoping structure is simple in form, requires no power, and reduces cost, thereby improving market competitiveness.

### BRIEF DESCRIPTION OF THE DRAWINGS:

FIG. 1 is a perspective view of Embodiment 1;

FIG. 2 is another perspective view of Embodiment 1;

FIG. 3 is a sectional view of Embodiment 1;

FIG. 4 is an assembly detail of first outer housing with vibration device and guide rods in Embodiment 1;

FIG. 5 is a perspective view of the second massage module in Embodiment 1;

FIG. 6 is a perspective view of the first massage member in Embodiment 1;

FIG. 7 is a perspective view of the second massage member in Embodiment 1;

FIG. 8 is a perspective view of Embodiment 2;

FIG. 9 is a sectional view of Embodiment 2;

FIG. 10 is a structural view of Embodiment 3;

FIG. 11 is a perspective view of Embodiment 4;

FIG. 12 is a sectional view of Embodiment 4;

FIG. 13 is a perspective view of Embodiment 5;

FIG. 14 is a sectional view of Embodiment 5;

FIG. 15 is a perspective view of Embodiment 6;

FIG. 16 is a sectional view of Embodiment 6;

FIG. 17 is an internal structural view of Embodiment 6;

FIG. 18 is another sectional view of Embodiment 6.

### DETAILED DESCRIPTION OF THE EMBODIMENTS

The following embodiments illustrate the present invention in detail with reference to the accompanying drawings. Identical reference numerals denote identical elements throughout.

### Embodiment 1

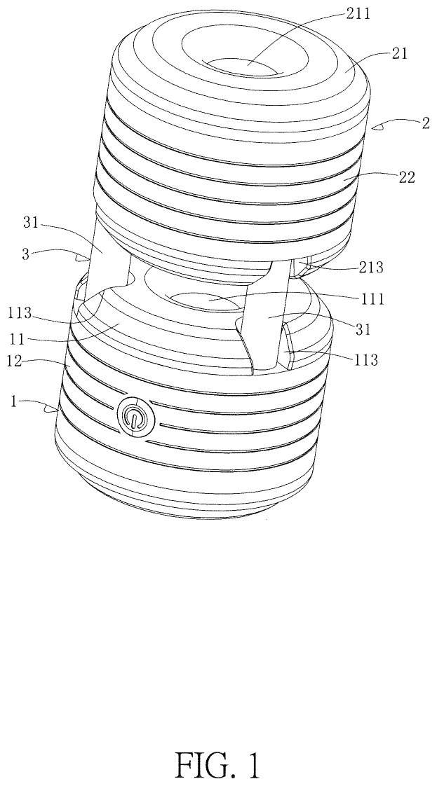

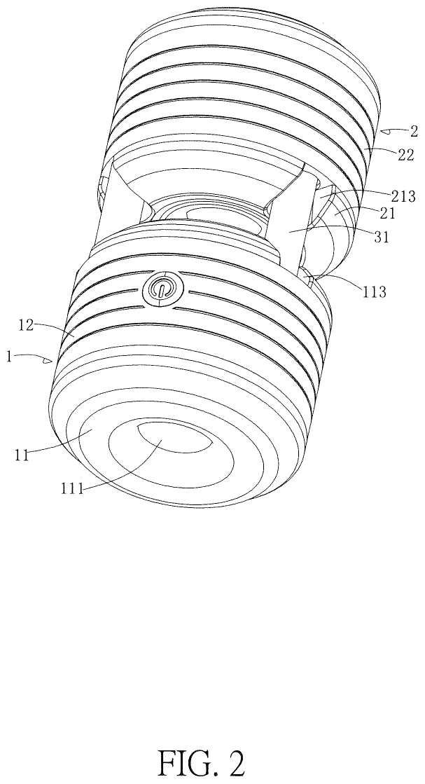

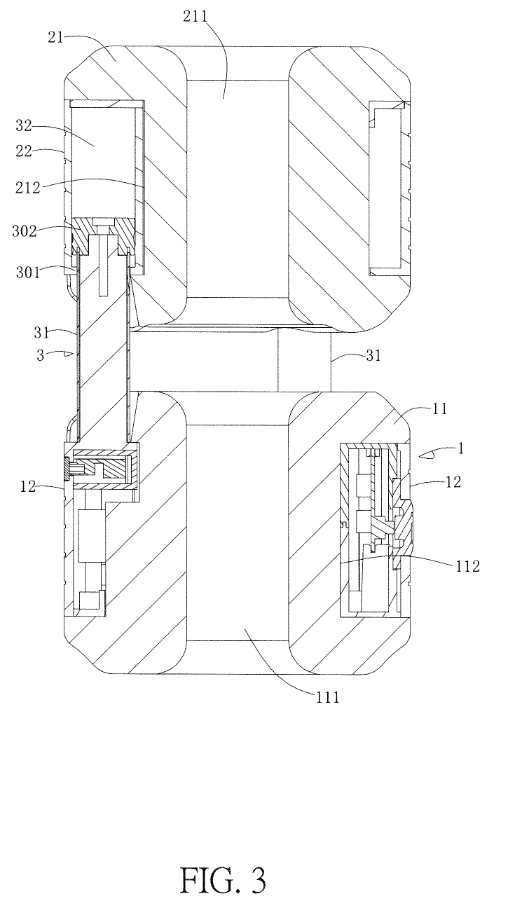

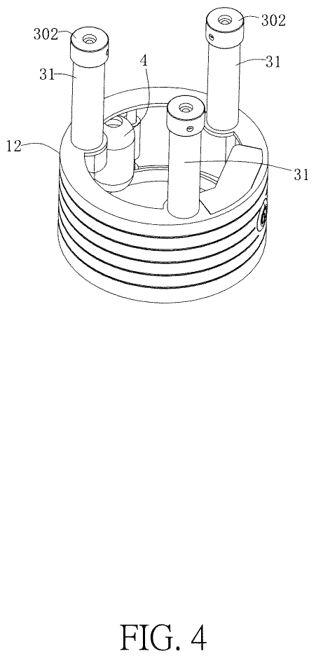

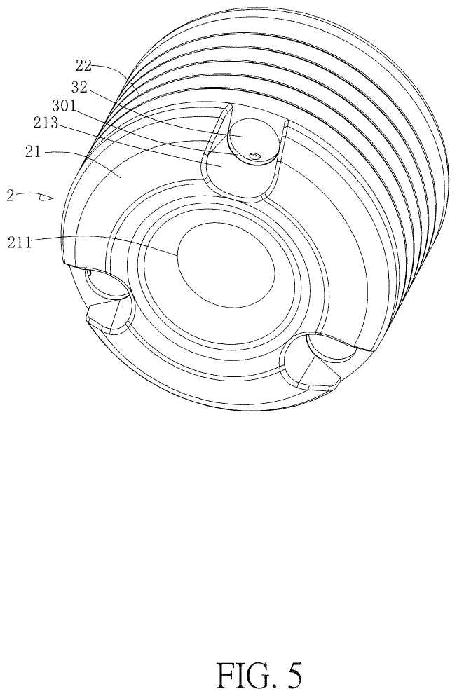

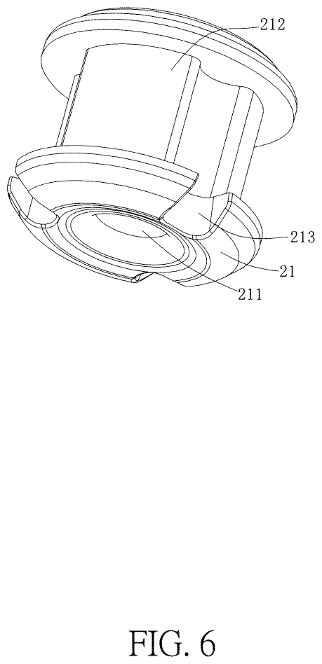

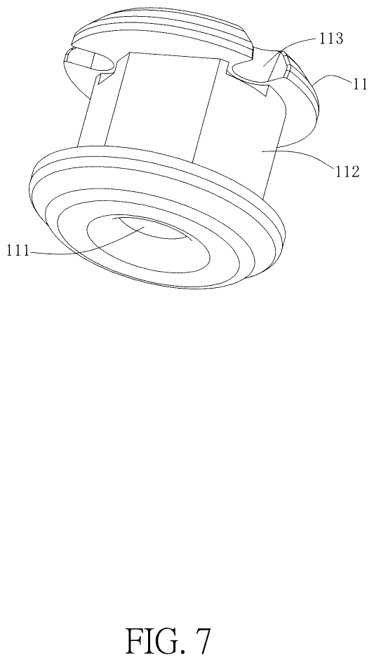

As shown in FIGS. 1-7, the manual telescoping massage device comprises first massage module 1, second massage module 2, and unpowered telescoping structure 3. Telescoping structure 3 connects between first massage module 1 and second massage module 2 so that second massage module 2 is mounted on the upper end of first massage module 1 for relative telescoping movement. First massage module 1 includes first massage member 11 with first massage channel 111; second massage module 2 includes second massage member 21 with second massage channel 211; second massage channel 211 aligns with and is spaced above first massage channel 111. That is, the unpowered telescoping structure 3 interconnects first massage module 1 and second massage module 2 to form a manual telescoping massage device. First massage member 11's channel provides initial massage, and by manually telescoping second massage module 2 relative to first massage module 1, second massage member 21's channel provides secondary segmented massage, satisfying varied user requirements. The simple, power-free structure reduces cost and enhances market competitiveness.

Second massage channel 211 is provided with massage folds or massage nodules that enhance the massage effect during reciprocal movement over an object (e.g., a male penis), increasing comfort.

First massage module 1, telescoping structure 3, and second massage module 2 combine to form a dumbbell shape, increasing appeal. Preferably, first massage module 1 and second massage module 2 share the same external profile, each bearing multiple annular grooves resembling weight plates.

First massage member 11 and second massage member 21 are made of silicone. A vibration device 4 may be fixed inside the first or second outer housing to contact and vibrate first massage member 11 and/or second massage member 21. In a preferred variant, vibration device 4 is fixed inside first outer housing 12 and contacts first massage member 11 to provide a vibratory massage.

In this embodiment, telescoping structure 3 comprises guide rods 31 fixed to first massage module 1 and slide-slots 32 in second massage module 2; each guide rod 31 slides within a corresponding slide-slot 32, providing stable support.

To improve stability, an anti-disengagement structure is provided between guide rods 31 and slide-slots 32 to prevent separation and extend service life. Two variants are possible:

Constricted mouth 301 at the lower end of slide-slot 32 and anti-disengagement block 302 on guide rod 31, block 302 sliding within slot 32 but unable to pass through mouth 301, reducing friction and wear.

Travel-limit block on slide-slot 32's inner wall and travel-limit groove on guide rod 31's outer side, block engaging groove.

The first variant is preferred.

First massage module 1 further includes first outer housing 12 seated in annular groove 112 of first massage member 11; guide rods 31 are fixed to first outer housing 12. Second massage module 2 includes second outer housing 22 seated in annular groove 212 of second massage member 21; slide-slots 32 are formed at the lower end of second outer housing 22. A first relief groove 113 at the upper end of first massage member 11 and a second relief groove 213 at the lower end of second massage member 21 accommodate guide rods 31 and improve assembly stability.

In summary, the present invention's unpowered telescoping structure 3 interconnects first and second massage modules for manual telescoping, delivering segmented massage without power, reducing cost, and improving market competitiveness.

### Embodiment 2

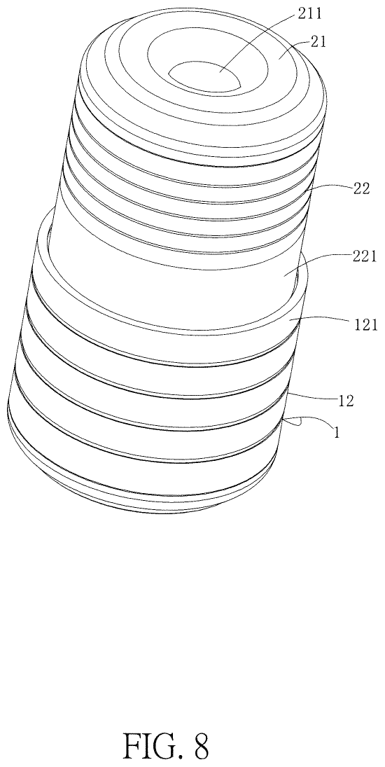

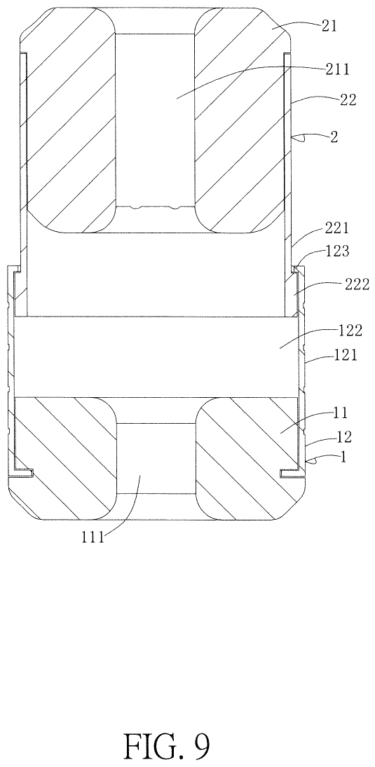

The difference from Embodiment 1 lies in the telescoping structure. As shown in FIGS. 8-9, first outer housing 12 extends upward beyond first massage member 11 to form extension tube 121 with slide-slot 122; second outer housing 22 extends downward beyond second massage member 21 to form sliding tube 221 that is slidably received in slide-slot 122, forming telescoping structure 3. Extension tube 121's upper end carries anti-disengagement flange 123, and sliding tube 221's lower end carries sliding flange 222; these flanges engage to prevent separation. Other structures match Embodiment 1.

### Embodiment 3

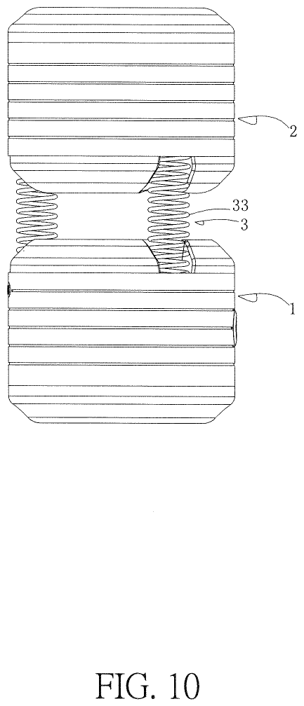

The difference from Embodiment 1 lies in telescoping structure 3. As shown in FIG. 10, telescoping structure 3 comprises springs 33 whose upper ends are fixed to first massage module 1's lower end and whose lower ends are fixed to second massage module 2's upper end. Springs 33 support and restore telescoping movement. Other structures match Embodiment 1.

### Embodiment 4

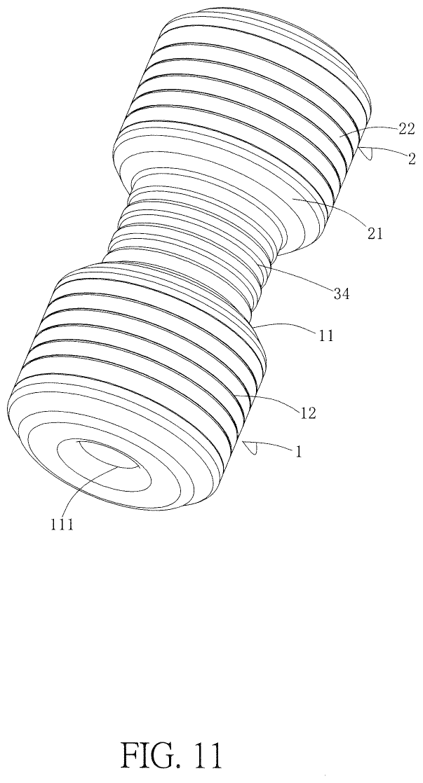

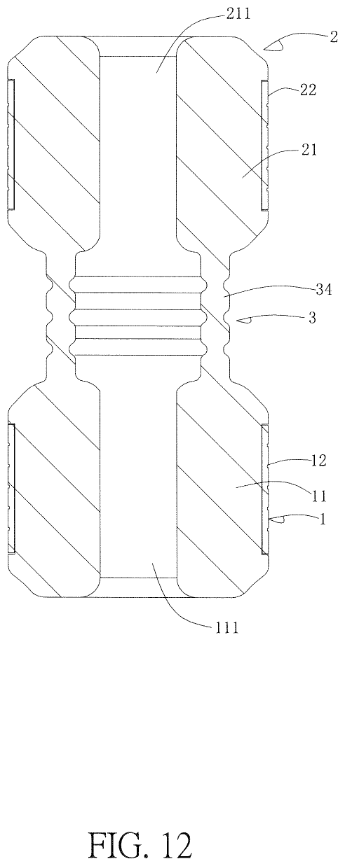

The difference from Embodiment 1 lies in telescoping structure 3. As shown in FIGS. 11-12, telescoping structure 3 comprises corrugated elastomeric bellows 34 integrally joined at its upper end to second massage member 21's lower end and at its lower end to first massage member 11's upper end. Bellows 34's internal cavity exceeds the massage channels' cross-sections to avoid obstruction. Bellows 34 compresses and restores movement. Other structures match Embodiment 1.

### Embodiment 5

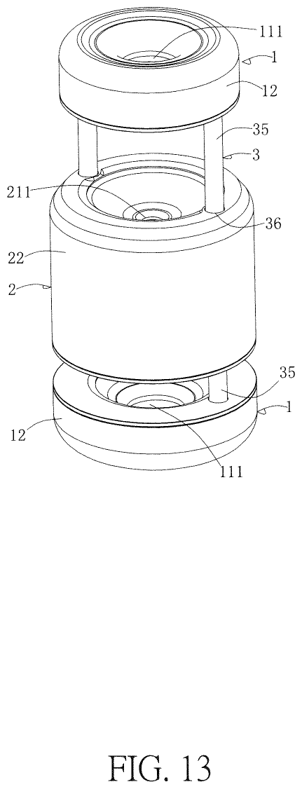

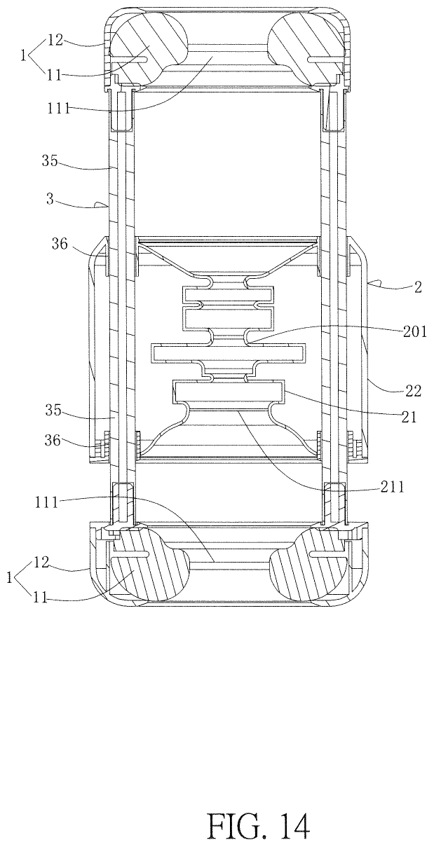

The difference from Embodiment 1 lies in telescoping structure and module count. As shown in FIGS. 13-14, two first massage modules 1 flank one second massage module 2. Telescoping structure 3 comprises guide rods 35 fixed between the two first modules and guide-slots 36 in second module 2. Second module 2 is sleeved on guide rods 35 via guide-slots 36 for smooth telescoping, with second massage channel 211 coaxial with first channels 111 of both first modules. Each first module includes first outer housing 12 fixed to guide rods 35, forming a stable frame. Second module 2 includes second outer housing 22 defining guide-slots 36. Other structures match Embodiment 1.

Second massage channel 211 includes massage folds 201 to enhance comfort during reciprocation.

### Embodiment 6

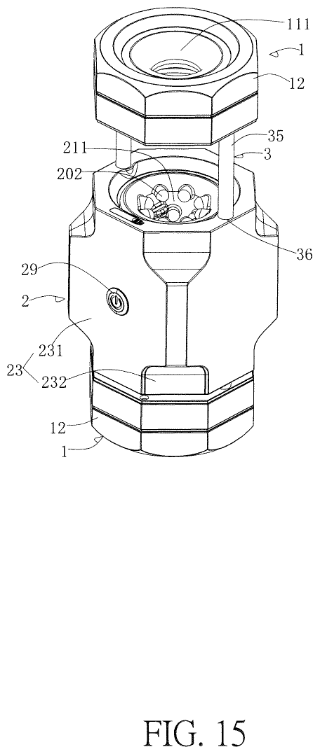

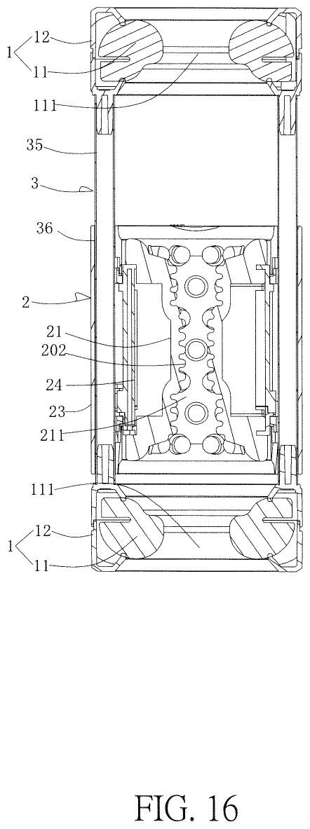

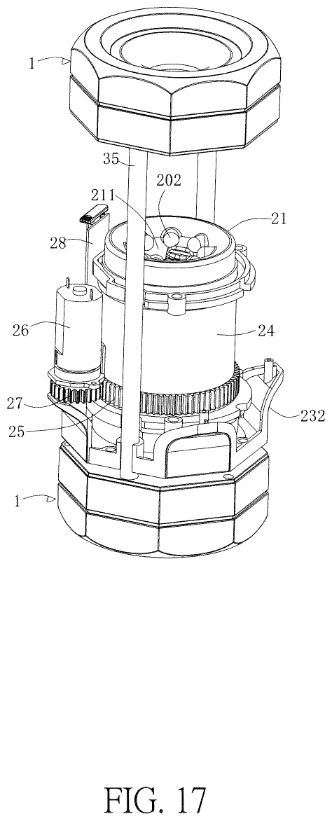

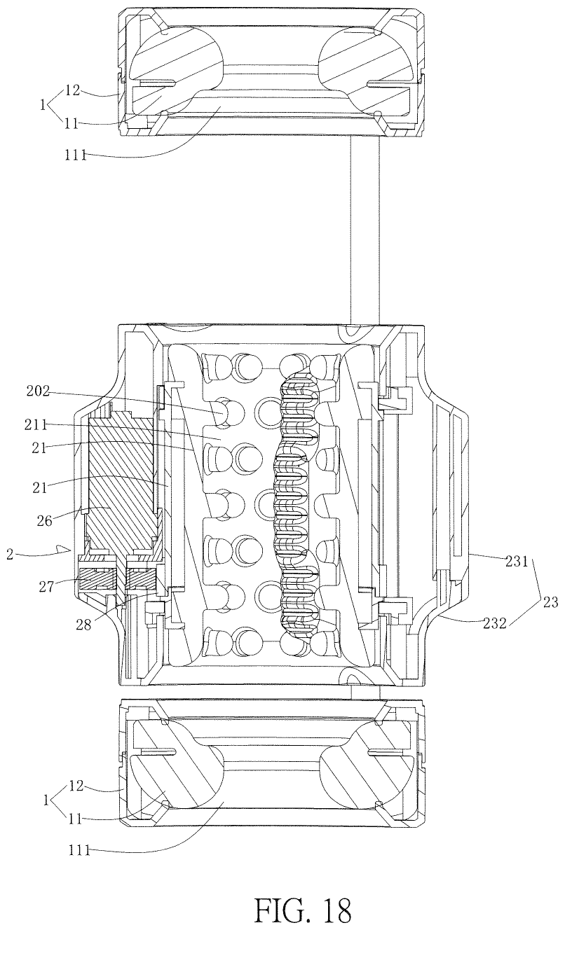

The difference from Embodiment 5 lies in second massage module 2's structure. As shown in FIGS. 15-18, second module 2 comprises rigid outer housing 23, rotatable inner housing 24, external gear ring 25 fixed to inner housing 24's lower end, motor 26 inside housing 23, and driving gear 27 on motor shaft meshing with ring 25; second massage member 21 mounts inside inner housing 24. Rigid housing 23 also houses guide-slots 36 and control circuit board 28 electrically connected to motor 26, plus control switch 29 externally connected to board 28. Actuating switch 29 drives motor 26, which turns gear 27 and ring 25, rotating inner housing 24 and massage member 21 to enhance massage.

Outer housing 23 comprises housing body 231 and lower end cover 232; inner housing 24 is rotatably supported between them.

Second massage channel 211 includes massage nodules 202 to further enhance comfort.

In summary, manual telescoping structure 3 interconnects the modules for segmented massage without power, and motor-driven rotation further enhances massage, all in a simple, low-cost form.

Of course, the above are merely specific embodiments and do not limit the scope of the invention. Equivalent variations or modifications based on the invention's structure, features, and principles fall within the scope of the present application.

I claim

1. A manual telescoping massage device, comprising:
a first massage module (1) having a first massage member (11) that defines a first massage channel (111);
a second massage module (2) having a second massage member (21) that defines a second massage channel (211); and
an unpowered telescoping structure (3) interconnecting the first massage module (1) and the second massage module (2) such that the second massage module (2) is mounted on an upper end of the first massage module (1) for relative telescoping movement, the second massage channel (211) being aligned with and spaced above the first massage channel (111).

2. The manual telescoping massage device according to claim 1, wherein the telescoping structure (3) comprises:
a plurality of guide rods (31) fixed to the first massage module (1); and
a plurality of telescoping slide-slots (32) formed in the second massage module (2), each guide rod (31) extending through a corresponding slide-slot (32) and being slidable within the corresponding slide-slot (32).

3. The manual telescoping massage device according to claim 2, wherein an anti-disengagement feature is provided between each guide rod (31) and a corresponding slide-slot (32), the anti-disengagement feature comprising either:
a constricted mouth (301) of reduced cross-section at a lower end of the slide-slot (32) and an anti-disengagement block (302) of larger cross-section mounted on an upper end of the guide rod (31), the anti-disengagement block (302) being slidable within the slide-slot (32) but too large to pass through the constricted mouth (301); or
a travel-limit block on an inner wall of the slide-slot (32) and a travel-limit groove on an outer side of the guide rod (31), the travel-limit block engaging the travel-limit groove to prevent separation of the guide rod (31) from the slide-slot (32).

4. The manual telescoping massage device according to claim 2, wherein the first massage member (11) carries an annular groove (112) in a mid-periphery of the first massage member (11), and a first outer housing (12) is seated in the annular groove (112) flush with an outer periphery of the first massage member (11), the guide rods (31) being fixed to the first outer housing (12);
the second massage member (21) carries an annular groove (212) in a mid-periphery of the second massage member (21), and a second outer housing (22) is seated in the annular groove (212) flush with an outer periphery of the second massage member (21), the lower end of the second outer housing (22) defining the slide-slots (32);
a first relief groove (113) is formed in an upper end of the first massage member (11) to accommodate the guide rods (31); and
a second relief groove (213) is formed in a lower end of the second massage member (21) to accommodate the guide rods (31).

5. The manual telescoping massage device according to claim 4, further comprising a vibration unit (4) mounted to contact an outer surface of the first massage member (11) or the second massage member (21), and wherein the combined first massage module (1), telescoping structure (3), and second massage module (2) presents a dumbbell-shaped appearance.

6. The manual telescoping massage device according to claim 1, wherein:
the first massage member (11) is enclosed by a first outer housing (12) that extends upward beyond an upper end of the first massage member (11) to form an extension tube (121) defining a slide-slot (122);
the second massage member (21) is enclosed by a second outer housing (22) that extends downward beyond a lower end of the second massage member (21) to form a sliding tube (221) which is slidably received in the extension tube's slide-slot (122) to form the telescoping structure (3);
an inward-turned anti-disengagement flange (123) is formed at an upper end of the extension tube (121); and
an outward-projecting flange (222) is formed at a lower end of the sliding tube (221), the outward-projecting flange (222) contacting an inner wall of the slide-slot (122).

7. The manual telescoping massage device according to claim 1, wherein the telescoping structure (3) comprises one or more springs (33), each spring (33) having an upper end fixed to a lower end of the first massage module (1) and a lower end fixed to an upper end of the second massage module (2).

8. The manual telescoping massage device according to claim 1, wherein the telescoping structure (3) comprises a corrugated elastomeric bellows (34), an upper end of the corrugated elastomeric bellows (34) being integrally joined to a lower end of the second massage member (21) and a lower end of the corrugated elastomeric bellows (34) being integrally joined to an upper end of the first massage member (11), the corrugated elastomeric bellows (34) defining an internal cavity larger than the first massage channel (111) and the second massage channel (211).

9. The manual telescoping massage device according to claim 1, wherein
two first massage modules (1) are provided;
one second massage module (2) is provided;
the telescoping structure (3) comprises guide rods (35) fixed between the two first massage modules (1) and guide-slots (36) formed in the second massage module (2), the second massage module (2) being sleeved on the guide rods (35) via the guide-slots (36) for telescoping movement along the guide rods (35); and
the second massage channel (211) is coaxially aligned with the first massage channels (111) of both first massage modules (1).

10. The manual telescoping massage device according to claim 9, wherein the second massage module (2) comprises:
a rigid outer housing (23);
a rotatable inner housing mounted within the rigid outer housing (23);
an external gear ring (25) fixed to a lower end of the rotatable inner housing (24);
a motor (26) housed within the rigid outer housing (23); and
a driving gear (27) mounted on a shaft of the motor (26) and meshing with the external gear ring (25);
the second massage member (21) being mounted within the rotatable inner housing (24);
a control circuit board (28) housed within the rigid outer housing (23) and electrically connected to the motor (26); and
a control switch (29) mounted on an exterior of the rigid outer housing (23) and electrically connected to the control circuit board (28).
